(19) United States
(12) Patent Application Publication
(10) Pub. No.: US 2006/0155652 A1
(43) Pub. Date: Jul. 13, 2006

(54) Expiring encryption

(76) Inventor: Steven M. Colby, Redwood City, CA (US)

Correspondence Address: STEVEN M. COLBY, P. O. BOX 52033, PALO ALTO, CA, 94303, US

(21) Appl. No.: 10/869,736

(22) Filed: Jun. 16, 2004

Related U.S. Application Data
(60) Provisional application No. 60/479,194, filed on Jun. 16, 2003.

(51) Int. Cl. G06F 17/60

(52) U.S. Cl. 705/59

(57) ABSTRACT

Systems and methods of time dependent encryption are disclosed. The systems and methods are optionally used to facilitate decryption following expiration of a copyright term. An example is provided using the DeCSS decryption algorithm.

### CROSS-REFERENCE TO RELATED APPLICATIONS

This application claims benefit of U.S. Provisional Patent Application No. 60/479,194 filed Jun. 16, 2003 and entitled “Expiring Encryption.” The disclosure of this application is herein incorporated by reference.

### BACKGROUND

1. Field of the Invention

The invention is in the field of data management and more specifically in the field of encryption.

2. Related Art

A number of encryption schemes have been developed in order to limit the distribution of digital information. For example, Adobe, Inc. has developed an encryption technology to restrict unauthorized copying and redistribution of electronic books. Likewise, a standard (CSS) has been developed for the protection of digital video and similar data.

These and other prior art encryption technologies may be used to facilitate enforcement of copyright rights. For example, a copyrighted digital video may be sold in an encrypted form do prevent unauthorized copying and redistribution.

It is a policy goal of the United States copyright statutes that copyrighted material become part of the public domain at the end of a statutory copyright term. However, the current approaches to protecting copyright using encryption do not support this policy because prior art encryption technologies continue to prevent copying and redistribution of encrypted materials even after copyright expiration.

### SUMMARY

Systems and methods of the invention include an encryption scheme that is responsive to expiration of copyright. This encryption scheme is configured to restrict unauthorized copying and redistribution of encrypted copyrighted data during the copyright term and to allow less restricted decryption, copying, and redistribution following the expiration of copyright. Some embodiments of the invention include encrypted digital media having encryption expiration data such as an encrypted copyright term expiration date. The encryption expiration data is interpreted by a decryption system that allows decryption of the digital media following the expiration of the copyright term. The decryption system includes a secure clock configured such that is cannot be tampered with in a manner that would allow unrestricted decryption prior to the copyright term expiration indicated by the encryption expiration data.

Various embodiments of the invention include a digital media having data encoded thereupon, the data comprising encryption expiration data configured to be used to determine expiration of a copyright term, the encryption expiration data being stored in a read-only form, and encrypted digital video data protected by copyright until expiration of the copyright term, the encrypted digital video data configured to be decrypted by a decryption system responsive to the expiration of the copyright term as determined using the encryption expiration data.

Various embodiments of the invention include a digital media playback device comprising a secure clock configured to provide a date output, the date output representing a date that is either equal to or prior to a current date, a media reader configured to read a digital media including encryption expiration data and encrypted digital video data, the encryption expiration data being representative of a copyright term expiration date associated with the encrypted digital video data, a logic circuit configured to compare the date output with the encryption expiration data, and configured to decrypt the encrypted digital video data responsive to the comparison, and a secure connection between the secure clock and the logic circuit.

Various embodiments of the invention include a secure clock comprising a power source, a time piece configured to produce a time dependent output, a static memory configured to store date data and to receive the time dependent output, the date data being advanced with a passage of time responsive to the time dependent output when power is available from the power source, and being stored in a non-volatile state when power is not available from the power source, and an output configured to provide a date output responsive to the date data stored in the static memory.

Various embodiments of the invention include a method of decrypting data, the method comprising reading encrypted digital data, reading encryption expiration data, receiving date data from a secure clock, comparing the encryption expiration data with the received date data, determining whether encryption has expired responsive to the comparison, and decrypting the encrypted digital data if the encryption has expired.

Various embodiments of the invention include a computer readable medium including computing instructions, the computing instructions comprising a code segment configured to determine if the encryption has expired, further decryption being responsive to the determination, a code segment configured to decrypt a sector of a digital versatile disk encrypted with the encryption, a code segment configured to decrypt a disk key using a player key, and a code segment configured to decrypt a title key using the decrypted disk key.

### BRIEF DESCRIPTION OF THE DRAWINGS

FIG. 1 is block diagram of a digital media including encrypted digital data and encryption expiration data, according to various embodiments of the invention;

FIG. 2 is a block diagram of a digital media playback device, according to various embodiments of the invention;

FIG. 3 is a block diagram of a secure clock, according to various embodiments of the invention;

FIG. 4 illustrates a method of decrypting data according to various embodiments of the invention; and

FIG. 5 illustrates computer instructions configured for decrypting digital video data, according to various embodiments of the invention.

### DETAILED DESCRIPTION

The invention includes systems and methods of decrypting digital data responsive to the expiration of copyright rights related to the digital data. At the time of decryption the status of the copyright is determined by comparing encryption expiration data, included with the digital data, with the output of a secure clock. If the comparison results in a determination that the copyright term on some or all of the digital data has expired, then a more extensive amount of decryption is preformed than if the associated copyright term has not expired. For example, in some embodiments, if the copyright has expired then decryption is performed to the extent that the digital data may be freely copied and redistributed. While, if the copyright has not expired, then decryption is performed only to the extent necessary to present the digital media on a local digital media playback device.

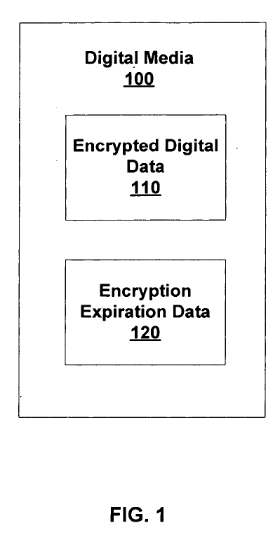

FIG. 1 is block diagram of a Digital Media 100 including Encrypted Digital Data 110 and Encryption Expiration Data 120, according to various embodiments of the invention. Encrypted Digital Data 110 typically includes encrypted digital audio data, encrypted digital video data, or the like. The encryption optionally configured such that date information is required to fully decrypt the encrypted data. Typically, all or part of Encrypted Digital Data 110 is subject to copyright protection at the time it is stored on Digital Media 100. The copyright protection being for a specific copyright term. In some embodiments various subsets of Encrypted Digital Data 100 may be subject to different copyright terms.

Encryption Expiration Data 120 is stored in read only memory (e.g., write once read many times) and includes information associated with a copyright term expiration date. For example, Encryption Expiration Data 120 typically includes an expiration date for a copyright term. The expiration date is optionally encrypted. In some embodiments Digital Media 100 includes a plurality of copies of Encryption Expiration Data 120 interspersed within Encrypted Digital Data 110. In some embodiments, Encryption Expiration Data 120 includes a plurality of different expiration dates related to a plurality of copyright terms for different subsets of Encrypted Digital Data 110.

Encryption Expiration Data 120 is configured to determine expiration of a copyright term and to control decryption of Encrypted Digital Data 110 responsive to that determination.

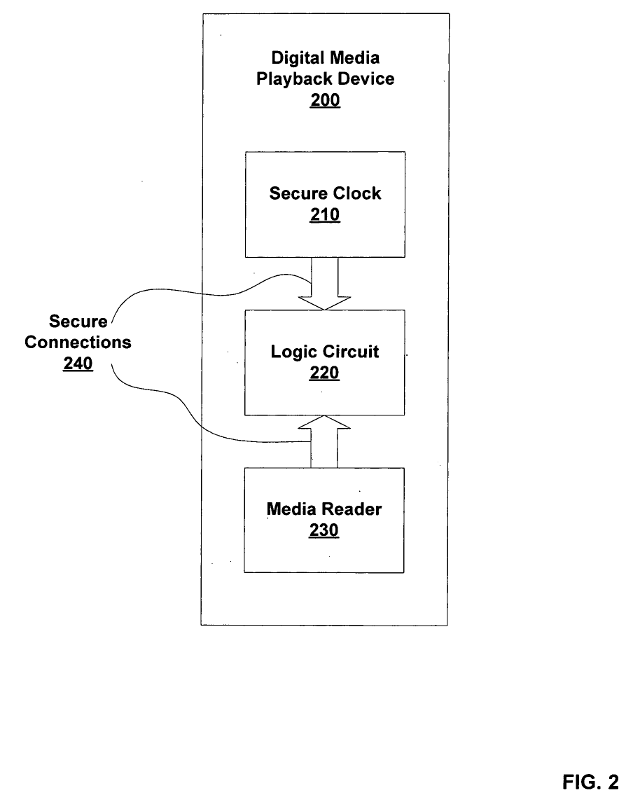

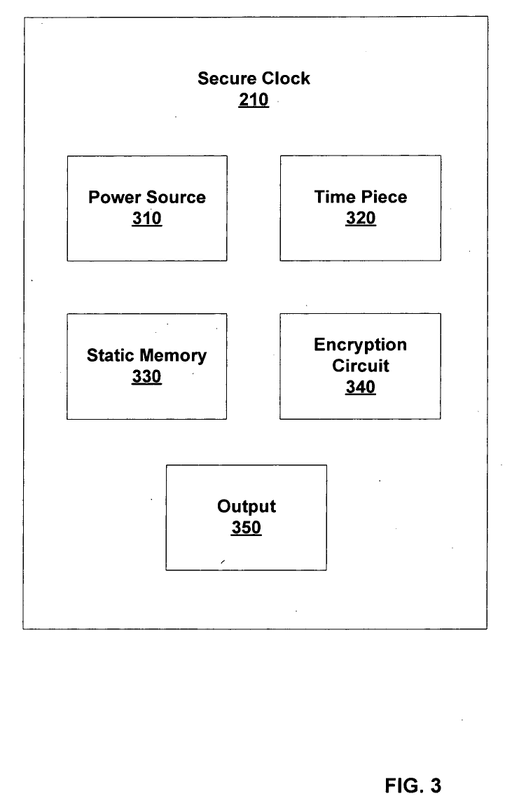

FIG. 2 is a block diagram of a Digital Media Playback Device 200, according to various embodiments of the invention. Digital Media Playback Device 200 includes a Secure Clock 210, a Logic Circuit 220, and a Media Reader 230. These elements are optionally interconnected by Secure Connections 240.

Secure Clock 210 is configured to provide a date output representing a date that is either equal to or prior to a current date. Thus, when Secure Clock 210 is initially set properly, Secure Clock 210 cannot be easily tampered with to generate a date output that is after the current date. The date output is optionally encrypted. In some embodiments, Secure Clock 210 is further configured to generate authentication data that can be used to authenticate the date output. Further details of Secure Clock 210 are described elsewhere herein.

Logic Circuit 220 is configured to decrypt Encrypted Digital Data 110 responsive to a date output received from Secure Clock 210 and Encryption Expiration Data 120. Logic Circuit 220 may include software, firmware or hardware configured to perform these and other tasks. For example, in some embodiments Logic Circuit 220 includes firmware configured to receive Encrypted Digital Data 110, to receive Encryption Expiration Data 120, to authenticate the received Encryption Expiration Data 120, to receive date output from Secure Clock 210, and to decrypt the received Encrypted Digital Data 110 based on a comparison between the received date output and the received Encryption Expiration Data 120. The decryption of the Encrypted Digital Data 110 is restricted if the comparison between the received date output and the Encryption Expiration Data 120 indicates that the copyright term has not yet expired. In contrast, a greater extent of decryption is performed if the comparison indicates that the copyright term has expired. In most embodiments complete encryption is enabled if the copyright term has expired.

In various embodiments, Logic Circuit 220 is configured to receive a plurality of Encryption Expiration Data 120 associated with different subsets of the received Encrypted Digital Data 110. In these embodiments the decryption of each subset is dependent on the Encryption Expiration Data 120 associated with that particular subset. Thus, different subsets of Encrypted Digital Data 110 may be decrypted to a different degree.

In various embodiments, Logic Circuit 220 is configured to authenticate the expiration date of a copyright term using authentication data included in Encryption Expiration Data 120.

Media Reader 230 is a data reader configured to read Encrypted Digital Data 110 from Digital Media 100. In some embodiments, Media Reader 230 is a digital versatile disk (DVD) reader and Digital Media 100 is a DVD. In some embodiments, Media Reader 230 is configured to read a hard disk, static read only memory, optical memory, magnetic memory, nano-based memory, or the like.

Optional Secure Connections 240 are configured for communicating date output from Secure Clock 210 to Logic Circuit 220, and/or for communicating encrypted Encrypted Digital Data 10 from Media Reader 230 to Logic Circuit 220. In some embodiments Secure Connections 240 are hardwired or optical connections. In some embodiments, Secure Clock 210, Logic Circuit 220 and/or Media Reader are disposed within a single package. For example, in some embodiments Secure Clock 210 and Logic Circuit 220 are included within the same integrated circuit package and one of Secure Connections 240 is an electrical connection within an integrated circuit.

FIG. 3 is a block diagram of Secure Clock 210, according to various embodiments of the invention. Secure Clock 210 includes a Power Source 310, a Time Piece 320, a Static Memory 330, an optional Encryption Circuit 340, and an Output 350. Secure Clock 210 is configured to provide a date output that is equal to or less than a current date (e.g., not later than the current date).

In some embodiments, Power Source 310 includes an internal source of power, such as a battery, fuel cell, capattery, kinetic power source, or the like. In some embodiments, Power Source 310 includes an external source of power such as a power cord connector, a photoreceptor, or the like.

Time Piece 320 is a device configured to generate a time dependent output that is in turn configured to measure the passage of time. For example, in some embodiments, Time Piece 320 is a crystal oscillator configured to generate electrical pulses at a well defined frequency.

Static Memory 300 is non-volatile memory configured to store date data regardless of the availability of power from Power Source 310. When power is available from Power Source 310 the time dependent output of Time Piece 320 is used to advance the date data stored in Static Memory 300 according to the passage of time. Preferably, the date data is advanced by one day for each actual day that passes. When power is not available from Power Source 310, or an alternative source, the date data is not advanced. Secure Clock 210 is configured such that the date data stored in Static memory 330 can be advanced but not turned back. Thus, if power is always available from Power Source 310 then the date data stored in Static Memory 330 will reflect the current date (assuming Static Memory 330 was properly initialized). If power was not available from Power Source 310 or some other source for a period of time, then the date data stored in Static Memory 330 will reflect a date prior to (but not later than) the current date. Typically, the date data stored in Static Memory 330 is initialized prior to delivery to an end user. For example, in some embodiments Static Memory 330 is initialized by a manufacturer of Secure Clock 210.

In alternative embodiments Secure Clock 210 is configured to measure elapsed time from an initialization event. In these embodiments, the initialization event may occur at a point of sale and/or include setting a memory location within Static Memory 330 to zero.

In order to assure that Secure Clock 210 provides a date output that is equal to or prior to a current date (the date on which the output is provided), Secure Clock 210 is first initialized to a date on which initialization occurs. This date is stored in Static Memory 330. During times in which power is available from Power Source 310 the date stored in Static Memory 330 is advanced with the passage of time responsive to the output of Time Piece 320. During times in which power is not available from Power Source 310 the date stored in Static Memory 330 is preserved in a non-volatile state. When power again becomes available from Power Source 310, the advancement of the stored date resumes from the preserved value.

In some embodiments, connections between Time Piece 320 and Static Memory 330 are configured to be secure. For example, in a typical embodiment, Time Piece 320 and Static memory 330 are disposed within the same integrated circuit package. The use of a secure connection reduces the possibility that Static Memory 330 could be manipulated into advancing the stored date data faster than the actual passage of time. In some embodiments, Static Memory 330 is configured not to recognize a time dependent output that occurs at a frequency significantly faster than that expected from Time Piece 320. For example, in some embodiments Static Memory 330 includes a passive filter (e.g., an RC filter) configured to pass time dependent signals at the frequency expected from Time Piece 320 (or a lower frequency). In some embodiments, the effects of a passive filter can be achieved through appropriate design of a time response of the internal circuitry of Static Memory 330. For example, if of a time required to update memory within Static Memory 330 is significantly long then the rate at which the date data can be improperly advanced is limited.

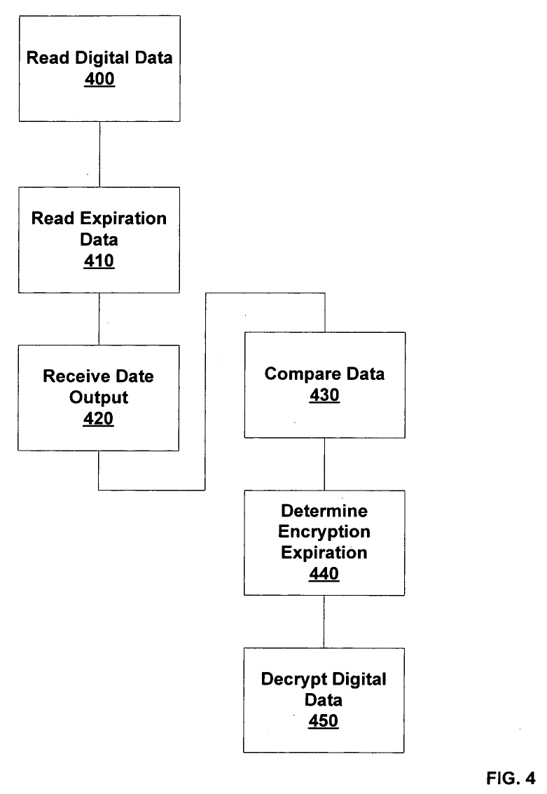

FIG. 4 illustrates a method of decrypting data according to various embodiments of the invention. The method includes reading Encrypted Digital Data 110, reading Encryption Expiration Data 120, receiving the date output of Secure Clock 210, comparing Encryption Expiration Data 120 with the date output of Secure Clock 210, determining if a copyright term has expired based on the comparison, and decrypting Encrypted Digital Data 110 responsive to the determination.

In a Read Digital Data Step 400, Encrypted Digital Data 110 is read from Digital Media 100 using Media Reader 230. For example, in one embodiment Encrypted Digital Data 110 includes digital video data encrypted using the CSS encryption scheme. Read Digital Data Step 400 may include reading all or a subset of Encrypted Digital Data 110.

In a Read Expiration Data Step 410, Encryption Expiration Data 120 is read from Digital Media 100 using Media Reader 230. The read Encryption Expiration Data 120 includes a date of an expiration of encryption. For example, in some embodiments Encryption Expiration Data 120 includes a date of encryption expiration that coincides with expiration of a copyright term and of associated encryption configured to enforce copyright rights. In these embodiments, the associated encryption may be configured to restrict copying and/or redistribution of the copyrighted material. In some embodiments, the read Encryption Expiration Data 120 further includes authentication data configured for authenticating the date of encryption expiration. In alternative embodiments, the expiring encryption may be for purposes other than protection of copyright rights.

The data read in Read Digital Data Step 400 and Read Expiration Data Step 410 is transferred to Logic Circuit 220, optionally using Secure Connections 240.

In a Receive Date Output Step 420, the date output of Secure Clock 210 is received by Logic Circuit 220. The received date output includes a date that is equal to or prior to a current date. In some embodiments, the received date output includes authenticating data.

In a Compare Data Step 430, the date output received in Receive Date Output Step 420 is compared with the date of encryption expiration read in Read Expiration Data Step 410.

In a Determine Encryption Expiration Step 440 the result of this comparison is used to determine if the encryption has expired. For example, if the current date, as determined from the date output received from Secure Clock 210, is prior to the date of an encryption expiration, then the encryption is considered not to have expired. Alternatively, if the current date is after the date of the expiration of encryption then the encryption is considered to have expired.

In a Decrypt Data Step 450, the Encrypted Digital Data 110 read in Read Expiration Data Step 410 is decrypted responsive to whether the encryption has expired. Typically, a greater amount of decryption is performed when the encryption has expired than when the encryption has not expired. For example, in some embodiments, Decrypt Data Step 450 includes complete decryption when the encryption has expired and partial decryption when the encryption has not expired. In some embodiments, Decrypt Data Step 450 includes partial decryption when the encryption has expired and no decryption when the encryption has not expired. In alternative embodiments, Encrypted Digital Data 110 is encrypted by a plurality of encryptions each having a different date of encryption expiration. In these embodiments, the passage of each encryption expiration date enables further decryption of Encrypted Digital Data 110.

Compare Data Step 430, Determine Encryption Expiration Step 440, and Decrypt Data Step 450 are typically performed by computing instructions included in Logic Circuit 220.

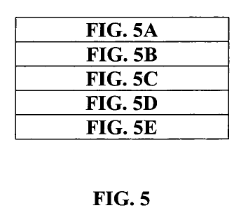

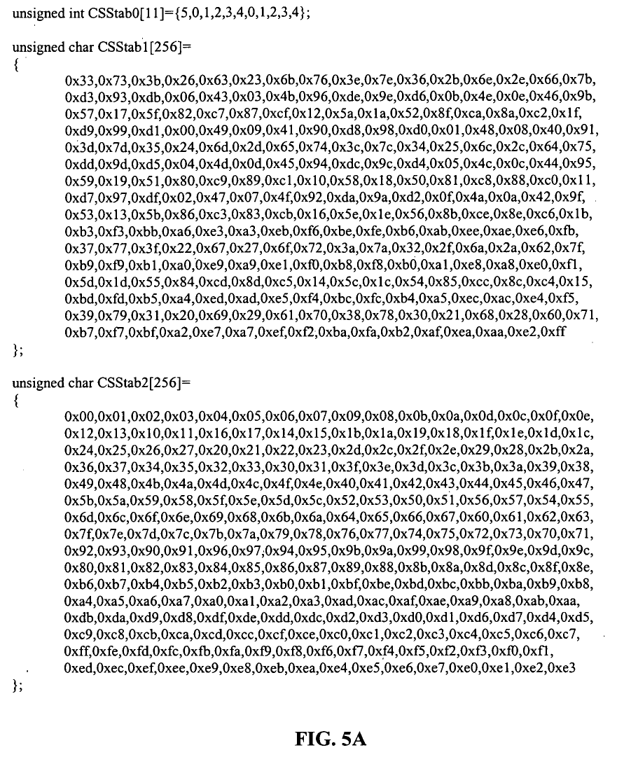

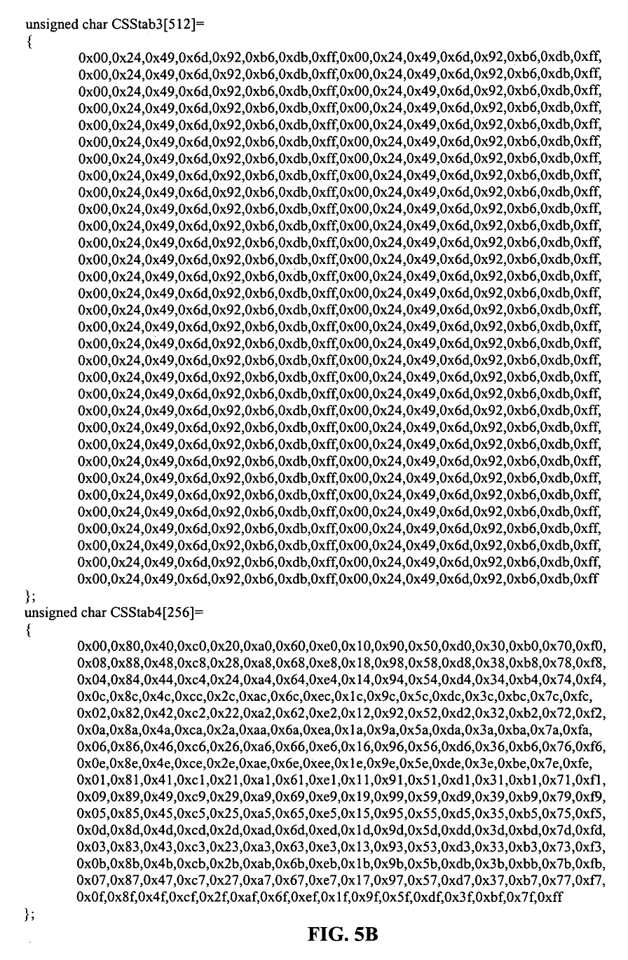

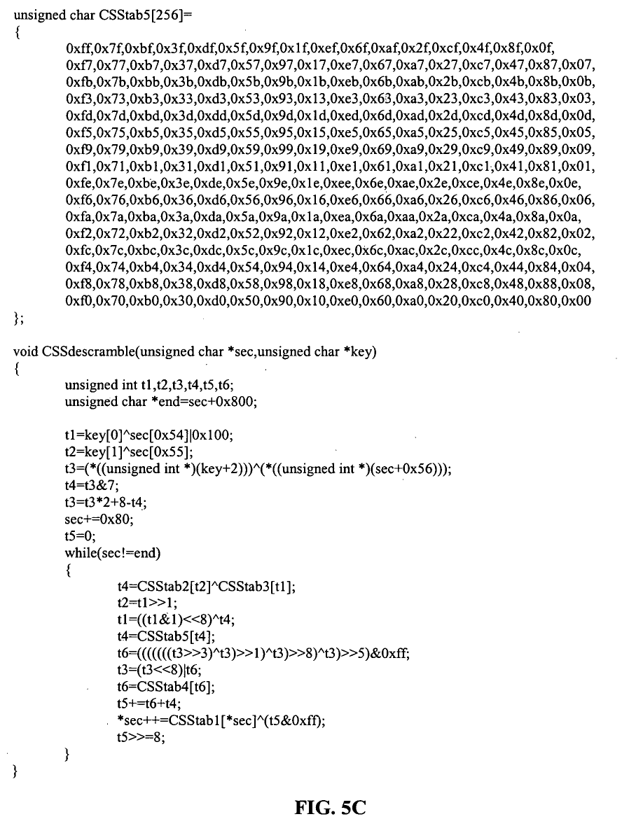

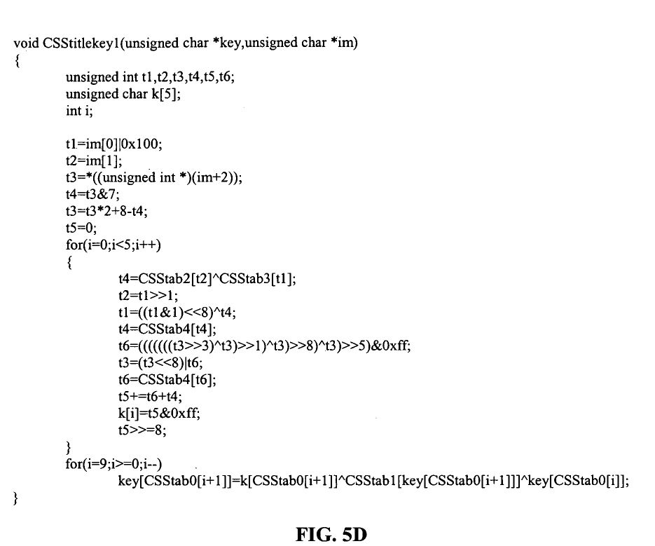

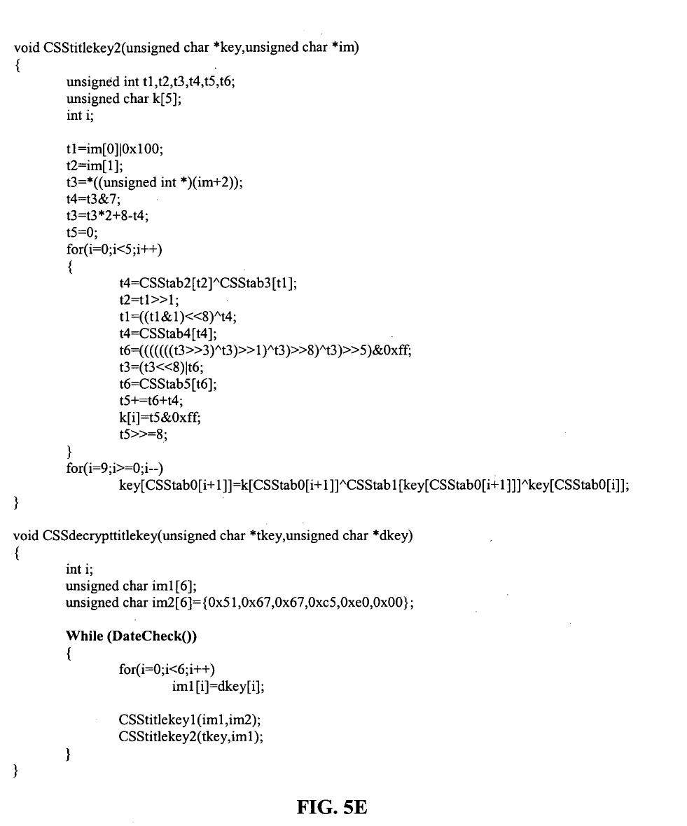

FIG. 5 illustrates Computer Instructions, generally designated 500 and configured for decrypting digital video data, according to various embodiments of the invention. The Computer Instructions 500 are a variation of a decryption program known as DeCSS and configured to decrypt digital media encrypted using the CSS encryption scheme. FIG. 5 illustrates an example of how this decryption code may be modified to facilitate the methods illustrated by FIG. 4.

Computer Instructions 500 include functions CSSdescramble 510, CSStitlekey1 520, CSStitlekey2 530, and CSSdecrypttitlekey 540. CSSdescramble 510 is configured to decrypt one 2048 byte sector of a DVD. CSStitlekey1 520 is configured to decrypt a disk key using a player key. CSStitlekey2 530 is configured to decrypt a title key using a decrypted disk key. And, CSSdecrypttitlekey 540 uses a built-in player key to decrypt a disk key and a title key. Further details of prior art aspects of Computer Instructions 500 can be found in “The CSS Decryption Algorithm” by David S. Touretaky at http://www-2.cs.cmu.edu/˜dst/DeCSS/Gallery/plain-english.html.

In the embodiments of the invention illustrated by FIG. 5, Lines 550 are added to the prior art aspects of Computer Instructions 500 in order to call a function DateCheck. The function DateCheck is configured to perform Compare Data Step 430 and Determine Encryption Expiration Step 440, and to return a TRUE value if the CSS encryption has expired. Thus, the instructions between Lines 550 are only executed if the encryption has expired.

The decryption program illustrated in FIG. 5 is included in some embodiments of Logic Circuit 220.

Several embodiments are specifically illustrated and/or described herein. However, it will be appreciated that modifications and variations are covered by the above teachings and within the scope of the appended claims without departing from the spirit and intended scope thereof. For example, in some embodiments the systems and methods described herein may be used for managing time dependent encryption other than that relating to copyright term.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

I claim:

1. A digital media having data encoded thereupon, the data comprising:
encryption expiration data configured to be used to determine expiration of a copyright term, the encryption expiration data being stored in a read-only form; and
encrypted digital video data protected by copyright until expiration of the copyright term, the encrypted digital video data configured to be decrypted by a decryption system responsive to the expiration of the copyright term as determined using the encryption expiration data.

2. The digital media of claim 1, wherein the encryption expiration data includes a date of expiration of the copyright term.

3. The digital media of claim 1, wherein the encryption expiration data is encrypted.

4. The digital media of claim 1, wherein the encryption expiration data includes a plurality of copies of a date of expiration of the copyright term.

5. The digital media of claim 1, wherein the encryption expiration data includes a plurality of dates of expiration applicable to different subsets of the encrypted digital video data.

6. (canceled)

7. (canceled)

8. (canceled)

9. (canceled)

10. A secure clock comprising:
a power source;
a time piece configured to produce a time dependent output;
a static memory configured to store date data and to receive the time dependent output, the date data being advanced with a passage of time responsive to the time dependent output when power is available from the power source, and being stored in a non-volatile state when power is not available from the power source; and
an output configured to provide a date output responsive to the date data stored in the static memory.

11. The secure clock of claim 10, further including an encryption circuit configured to encrypt the date output.

14. The secure clock of claim 10, wherein the static memory is configured not to respond to received time dependent signals above a particular frequency.

15. The secure clock of claim 10, wherein the static memory includes a frequency dependent filter.

16. (canceled)

17. (canceled)

18. (canceled)

19. (canceled)

20. (canceled)

21. A digital media playback device comprising:
a secure clock configured to provide a date output, the date output representing a date that is either equal to or prior to a current date;
a media reader configured to read a digital media including encryption expiration data and encrypted digital video data, the encryption expiration data being representative of a copyright term expiration date associated with the encrypted digital video data;
a logic circuit configured to compare the date output with the encryption expiration data, and configured to decrypt the encrypted digital video data responsive to the comparison; and
a secure connection between the secure clock and the logic circuit.

22. The digital media playback device of claim 21, wherein the logic circuit includes computer instructions configured to decrypt data encrypted using a CSS Decryption Algorithm.

23. The digital media playback device of claim 21, wherein the logic circuit includes computer instructions configured to decrypt multiple layers of encryption.

24. The digital media playback device of claim 21, wherein the logic circuit includes computer instructions configured to decrypt a title key.

25. A method of decrypting data, the method comprising:
reading encrypted digital data;
reading encryption expiration data;
receiving date data from a secure clock;
comparing the encryption expiration data with the received date data;
determining whether encryption has expired responsive to the comparison; and
decrypting the encrypted digital data if the encryption has expired.

26. The method of claim 25, wherein the encrypted digital data is digital video data.

27. The method of claim 25, wherein the encrypted digital data and the encryption expiration data are stored on the same digital media.

28. The method of claim 25, wherein decrypting the encrypted digital data includes decrypting an encrypted title key.

29. A computer readable medium including computing instructions, the computing instructions comprising:
a code segment configured to determine if the encryption has expired, further decryption being responsive to the determination;
a code segment configured to decrypt a sector of a digital versatile disk encrypted with the encryption;
a code segment configured to decrypt a disk key using a player key; and
a code segment configured to decrypt a title key using the decrypted disk key.
